(19) United States
(12) Patent Application Publication
(10) Pub. No.: US 2025/0230294 A1
(43) Pub. Date: Jul. 17, 2025

(54) REINFORCEMENT OF STYRENE-ACRYLONITRILE POLYMER BULK WITH GLASS NANOFIBERS TO INTRODUCE PHOTOLUMINESCENT BRICKS

(71) Applicant: KING FAISAL UNIVERSITY, AL-AHSA (SA)

(72) Inventors: HANY MOHAMED ABD EL-LATEEF AHMED, AL-AHSA (SA); MAI MOSTAFA KHALAF ALI, AL-AHSA (SA); MOHAMED GOUDA, AL-AHSA (SA); FAKIHA EL-TAIB HEAKAL, CAIRO (EG)

(21) Appl. No.: 18/412,276

(22) Filed: Jan. 12, 2024

(51) Int. Cl. C08K 3/105; C08K 7/14; C09K 9/00

(52) U.S. Cl. CPC C08K 3/105; C08K 7/14; C09K 9/00; C08K 2201/003

(57) ABSTRACT

A photochromic material can include strontium aluminate (SAN) nanoparticles included within styrene-acrylonitrile polymer (SAP) reinforced with electrospun glass nanofibers (EGN). In some embodiments, the photochromic material may be transparent. In other embodiments, the photochromic material may be scratch resistant. In some embodiments, the photochromic material may be configured to form bricks. In still other embodiments, the photochromic material may be configured to form smart windows. The electrospun glass nanofibers may be a toughening mediator in the SAP. The photochromic material may exhibit a green coloration after exposure to ultraviolet (UV) light. The SAN may have a diameter of about 6 nm to about 14 nm. The EGN may have a diameter of about 75 nm to about 300 nm. The photochromic material may be superhydrophobic.

### BACKGROUND

### 1. Field

The disclosure of the present patent application relates to a transparent and mechanically reliable plastic and, particularly, to a transparent and mechanically reliable plastic made by reinforcing styrene-acrylonitrile polymer with electrospun glass nanofibers and including strontium aluminate nanoparticles.

### 2. Description of the Related Art

Smart materials are employed in the creation of protection goods owing to their ability to respond to potentially harmful external stimuli such as extremely high temperatures and hazardous substances. Some smart materials either continue to emit light after switching off the illumination source, showing afterglow emission, or emit light beneath the excitation source to show fluorescence. Light-stimulated material may continue to emit light for a few seconds, showing phosphorescence, or for hours, showing afterglow emission.

Photochromism is the term for a light-stimulated change in color that takes place in a material when it is exposed to an illumination source and then regains its original color when the illumination source is moved away. Photochromism may have application in concrete, windows, anti-counterfeiting devices, electronic displays, ophthalmic lenses, sensors, and packaging.

Most materials that have UV-induced photochromism are colored using organic colorants. However, the limitations of UV-induced chromic organic pigments include poor photostability, photochromism inhibition, and expensive cost, which restricts their applicability. The organic pigments photochromism relies on have structural switching. Thus, their photochromic activity is frequently inhibited by steric effects brought on by immobilization in bulk materials. Additionally, continued exposure to UV light may cause organic colorants to gradually photodegrade, resulting in poor photostability. However, no steric effects occur with photochromic inorganic colorants. As a result, photochromic inorganic colorants have enhanced photochromic properties and strong photostability.

Due to their excellent photostability, strontium aluminate nanoparticles (SANs) have better resistance to fatigue.

Persistent luminescent nanoparticles (PLNPs) are those which can store an amount of energy locally and release it slowly in the form of light. A few of the most known applications include glow-in-the-dark stickers and toys as well as indiglo face watches. Thus far, nearly all fundamental and applied research on these materials has focused on persistent luminescence in the visible region. However, there is nothing prohibiting the proposed persistent luminescent mechanisms from taking place in other spectral regions, namely the near-infrared. As such, there is a fundamental science need to explore this phenomenon in other spectral regions to further the understanding of the physical principles involved.

There are many practical and entrepreneurial applications of PLNPs and materials comprising PLNPs, yet there has been very little published research on incorporating persistent luminescent materials into textiles and fabrics. Beyond the novelty of incorporating these materials, there are unexplored real-world applications for low-light identification of individuals. Specifically, tactical missions and search-and-rescue operations would benefit greatly from their use, providing an ability to identify and locate individuals at a distance in low-light situations without external light sources like spotlights or reflecting lasers.

Thus, a transparent and mechanically reliable plastic having long lasting luminescent properties is desired.

### SUMMARY

To develop photochromic materials with persistent and long-lasting photoluminescence, such as bricks and smart windows, electrospun glass nanofibers (EGN) are incorporated into styrene-acrylonitrile polymer (SAP), such as, by way of non-limiting example, SAP films or sheets, for reinforcement. Strontium aluminate nanoparticles (SAN) are physically embedded into and/or included in the styrene-acrylonitrile polymer films to produce transparent and mechanically reliable plastic, such as, for example, EGN@SAP bricks or smart windows. Electrospinning is utilized to create EGN, which is subsequently included as a toughening mediator into styrene-acrylonitrile plastic to boost its mechanical properties.

Transparency of the EGN@SAP with the capacity to shift to green coloration under ultraviolet (UV) illumination was verified by spectral analyses using photoluminescence and International Commission on Illumination (CIE) Lab parameters. The EGN-SAP hybrids with low quantities of SAN were found to immediately reverse this emission activity, i.e., the photochromic feature, after removing the ultraviolet source, which suggest fluorescence emission. Afterglow emission from the EGN@SAP embedded with high concentrations of SAN persisted for a longer time and was less easily reversed. After excitation at 365 nm, the emission peaked at 519 nm.

The chemical structure of SAN was verified by X-ray diffraction (XRD). Transmission electron microscope (TEM) and scanning electron microscope (SEM) were utilized to explore the morphological properties of SAN and EGN, showing diameters of about 6 to about 14 nm and about 75 to about 300 nm, respectively. X-ray fluorescence (XRF), energy-dispersive X-ray (EDX), and SEM were employed to investigate the morphological features of the EGN@SAP composites.

As compared to SAN-free EGN@SAP bricks, the EGN@SAP bricks demonstrated improved scratch resistance. The hydrophobicity and UV resistance of the EGN@SAP bricks were improved with an increase in the concentration of SAN.

Accordingly, in an embodiment, the present subject matter relates to a photochromic material that can include strontium aluminate nanoparticles (SAN) embedded into styrene-acrylonitrile polymer (SAP). The SAP may be further reinforced with electrospun glass nanofibers (EGN) incorporated therein. In some embodiments, the material may be transparent. In other embodiments, the material may be scratch resistant. In some embodiments, the material may be configured to form bricks. In still other embodiments, the material may be configured to form smart windows. The electrospun glass nanofibers may be a toughening mediator in the SAP. The photochromic material may exhibit a green coloration after exposure to ultraviolet (UV) light. The SAN may have a diameter of about 6 nm to about 14 nm. The EGN may have a diameter of about 75 nm to about 300 nm.

These and other features of the present subject matter will become readily apparent upon further review of the following specification.

### BRIEF DESCRIPTION OF THE DRAWINGS

FIGS. 1A, 1B, and 1C shows transmission electron microscope (TEM) photos of embodiments of strontium aluminate nanoparticles (SAN) as described herein.

FIG. 2 shows an x-ray diffraction (XRD) spectral analysis of SAN (top) and the standard pattern of strontium aluminum oxide (bottom).

FIGS. 3A and 3B show SEM images of the electrospun glass nanofibers.

FIG. 4A-4D shows SEM analysis of embodiments of EGN@SAP photochromic materials with various SAN contents by weight percent, with FIGS. 4A and 4B depicting SAN₀ and FIGS. 4C and 4D depicting SAN₈.

FIG. 5 shows a graph of the excitation analysis of embodiments of EGN@SAP photochromic material at various SAN concentrations.

FIG. 6 shows a graph of the emission spectra of EGN@SAP photochromic material (SAN₆) at several UV-illumination intervals (100-400 s).

FIG. 7 shows a graph of contacting angles (C.A.) and ultraviolet protection factors (UPF) of embodiments of the EGN@SAP photochromic material as a function of SAN content.

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not. For example, “optionally substituted alkyl” means either “alkyl” or “substituted alkyl,” as defined herein.

It will be understood by those skilled in the art with respect to any chemical group containing one or more substituents that such groups are not intended to introduce any substitution or substitution patterns that are sterically impractical and/or physically non-feasible.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

A photochromic material as described herein can include strontium aluminate nanoparticles (SAN) included within styrene-acrylonitrile polymer (SAP). The SAP may further include electrospun glass nanofibers (EGN) incorporated therein. In some embodiments, the photochromic material may be transparent. In other embodiments, the photochromic material may be scratch resistant. In additional embodiments, the photochromic material may be configured to form bricks. In still other embodiments, the photochromic material may be configured to form smart windows. The electrospun glass nanofibers may be a toughening mediator in the SAP. The photochromic material may exhibit a green coloration after exposure to ultraviolet (UV) light. The SAN may have a diameter of about 6 nm to about 14 nm. The EGN may have a diameter of about 75 nm to about 300 nm.

In another embodiment, the present subject matter relates to a method of forming a photochromic material as described herein. In one embodiment, the synthetic method can begin with the synthesis of SAN, which starts by stirring a mixture of absolute ethanol, H₃BO₃, SrCO₃, Dy₂O₃, Eu₂O₃, and Al₂O₃ for about 3 hours. The mixture can then be ultrasonicated, for example, at about 35 kHz, for about 1 hour, heated at about 90° C. to about 99° C., or at about 95° C., for about 3 hours, and then milled for about 4 hours. The obtained powder can be reductively sintered at about 1300° C. to about 1400° C., or at about 1350° C., for about 3 hours under a carbon atmosphere, then milled and sieved to create a strontium aluminate micropowder having a particle size of about 17 μm to about 31 μm. The aluminate powder is then transformed into nanoparticles by a top-down process. The strontium aluminate powder is placed in a ball mill vial mounted on an oscillating disc. SAN were produced by subjecting the vibrating disc and the strontium aluminate powder to continuous hits for about 21 hours with a silicon carbide ball mill with diameter of about 0.1 cm.

Separately, the present synthetic methods can include electrospinning of glass nanofibers (EGN). EGN can be prepared by the dispersion of 3-tetraethyl-orthosilicate and polyvinyl pyrrolidone in a solvent combination of DMSO/DMF. The admixture is then subjected to pyrolysis at about 750° C. to about 850° C., or at about 800° C. EGN are sonicated for 10 minutes while being suspended in distilled water. Heat, for example at about 50° C. to about 60° C., or at about 55° C., and stirring, for example, at about 125 rpm, can be used to disperse the EGN in an ethanolic silane solution. Sonication can proceed in ethyl alcohol for about 10 minutes, followed by ethanol washing and desiccation to prepare the EGN.

Then, styrene-acrylonitrile polymer such as, by way of non-limiting example, recycled styrene-acrylonitrile polymer waste, is dissolved in 1,2-dichloroethane by stirring for about 1 hour. Both the SAN and the EGN obtained above are added to the provided solution. The generated solution is homogenized for about 1 h, and then stirred for an extra 3 h to ensure a homogeneous dispersion of EGN and SAN in the styrene-acrylonitrile polymer solution.

To create styrene-acrylonitrile plastic bricks, different amounts of SAN, including 0% (SAN₀), 0.5% (SAN₁), 1% (SAN₂), 2% (SAN₃), 4% (SAN₄), 6% (SAN₅), 8% (SAN₆), 10% (SAN₇), and 12% (SAN₈) w/w, are used. EGN@SAP bricks measuring about 7 cm in length, about 5 cm in thickness, and about 3 cm in width are produced by casting the given mixtures in a block-like aluminum mold by air-drying over-night, and then drying in a vacuum oven at about 60° C. to about 70° C., or at about 65° C. for about 6 h.

The following examples illustrate the present teachings.

### Example 1

### Synthesis of SAN

A mixture of 500 mL of absolute ethanol, 0.2 mol of H₃BO₃, 1 mol of SrCO₃, 0.03 mol of Dy₂O₃, 0.02 mol of Eu₂O₃, and 2 mol of Al₂O₃ was mechanically stirred for 3 h. The mixture was ultrasonicated (35 kHz) for 1 hour, heated (95° C.) for 3 h, and then milled for 4 hours. The given powder was reductively sintered (1350° C.) for 3 h under a carbon atmosphere, then milled and sieved to create strontium aluminate micropowder (17-31 μm). Then, the produced strontium aluminate powder was transformed into nanoparticles by the top-down process. The strontium aluminate powder (10g) was placed in a ball mill vial (20 cm) mounted on an oscillating disc. SAN were produced by subjecting the vibrating disc and the strontium aluminate powder to continuous hits for 21 hours with a silicon carbide ball mill with diameter of 0.1 cm.

### Example 2

### Electrospinning of EGN

EGN were prepared by the dispersion of 3-tetraethyl-orthosilicate (15%; w/w) and polyvinyl pyrrolidone (15%; w/w) in a solvent combination of DMSO/DMF (½). The admixture was then subjected to pyrolysis (800° C.). EGN were sonicated for 10 minutes while being suspended in distilled water (5-7%; w/w). Heat (55° C.) and stirring (125 rpm) were used to disperse the EGN in an ethanolic silane solution (15%; w/w). Sonication in ethyl alcohol for 10 minutes, followed by ethanol washing and desiccation, was used to prepare EGN.

### Example 3

### Preparation of EGN@SAP Bricks

Styrene-acrylonitrile polymer (SAP) was dissolved in 1,2-dichloroethane by mechanical stirring for in 1 h. Both of EGN (2.5%) and SAN (dried in vacuum oven (65° C.) to get rid of moisture) were added to the provided solution. The generated solution was homogenized (35 kHz) for 1 h, and then mechanically stirred for extra 3 h to ensure a homogeneous dispersion of EGN and SAN in the styrene-acrylonitrile polymer solution. To create styrene-acrylonitrile plastic bricks, various concentrations of SAN were utilized, including 0% (SAN₀), 0.5% (SAN₁), 1% (SAN₂), 2% (SAN₃), 4% (SAN₄), 6% (SAN₅), 8% (SAN₆), 10% (SAN₇), and 12% (SAN₈) w/w. EGN@SAP bricks measuring 7 cm in length, 5 cm in thickness, and 3 cm in width were produced by casting the given mixtures in a block-like aluminum mold by air-drying over-night, and then drying in vacuum oven (65° C.) for 6 h.

### Example 4

### Morphological Characterization

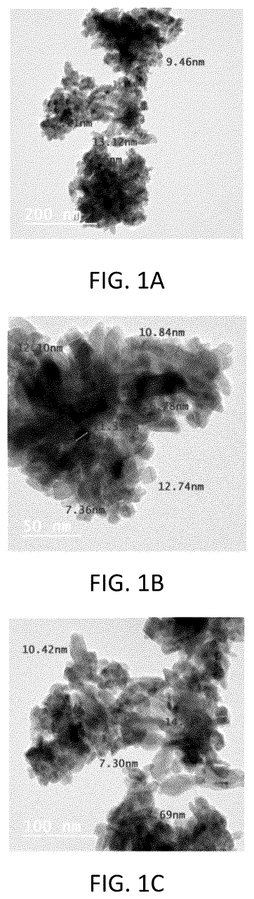

SAN were produced by first creating the strontium aluminate micropowder using the solid-state high temperature procedure, followed by the top-down approach. TEM analysis measured the diameter of SAN between 6 and 14 nm (FIGS. 1A-1C). A matrix transparency is often maintained by nanoparticles. Thus, SAN maintained transparency of EGN@SAP bricks. EGN@SAP was prepared with varying amounts of SAN. Electrospinning was utilized to create EGN. Hydrophobic, UV-protective, afterglow, and photochromic EGN@SAP bricks were developed.

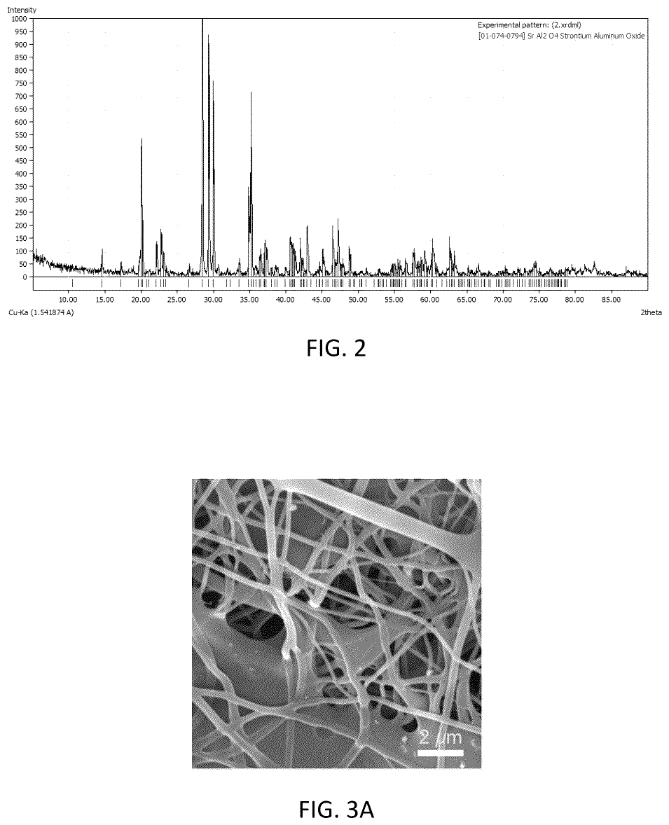

SAN were analyzed by XRD, as illustrated in FIG. 2. The diffraction signals observed for SAN were similar to those for monoclinic strontium aluminum oxide. Strontium aluminum oxide does not have any Eu²⁺ or Dy³⁺ peaks in its crystal structure, indicating a low temperature monoclinic phase.

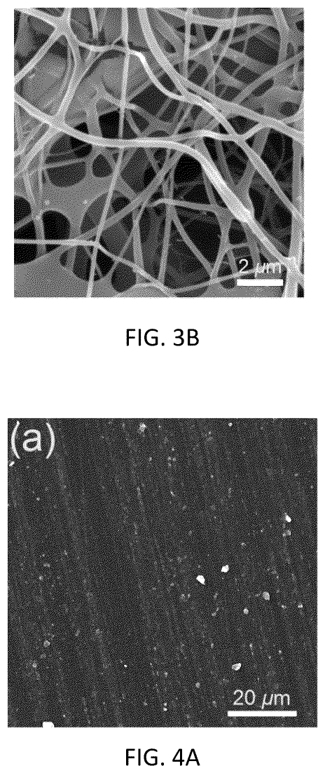

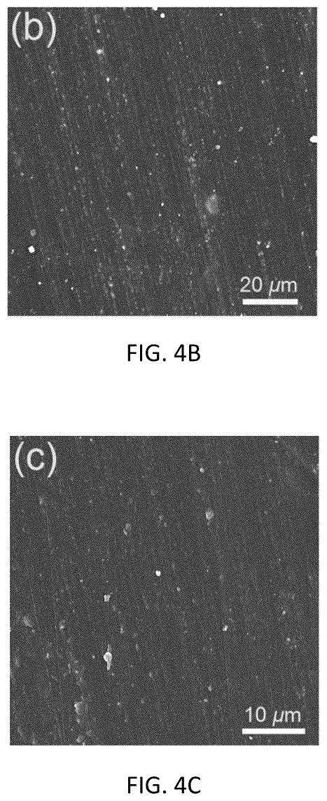

The topographical properties of EGN and luminescent EGN@SAP bricks are shown in FIGS. 3A-3B and FIGS. 4A-4D, respectively. Table 1, below, displays EDS spectroscopy utilized to explore the elemental composition of EGN@SAP at three separate positions. The topography of EGN@SAP bricks barely changed when the SAN ratio was raised. As shown in the SEM images, SAN nanoparticles were undetected on the surface of the tested EGN@SAP bricks. Thus, it can be concluded that SAN nanoparticles were entirely embedded inside the matrix of the EGN@SAP bricks. FIGS. 3A-3B show SEM evidence that the produced EGN have sizes between 75 and 300 nm.

Alkaline earth aluminate was found to be present in the brick mass by EDX analysis. To evaluate the chemical composition of the EGN@SAP blocks, EDXA analysis was performed at three separate sites. SAN were homogeneously dispersed within the bulk of the EGN@SAP bricks, with approximately equal elemental contents at each of the three studied sites. The presence of many elements was verified by EDX analysis, as indicated in Table 1. EGN@SAP consisted of oxygen, silicon, nitrogen, and carbon because of the styrene-acrylonitrile plastic host and the EGN reinforcing agent. The use of SAN required the addition of a plethora of other elements, such as aluminum, europium, strontium, and dysprosium. As a result of the low concentrations of SAN employed in the manufacturing of EGN@SAP films, traces of europium, dysprosium, strontium, and aluminum were detected. Oxygen, silicon, nitrogen and carbon were found in high enough quantities to confirm that EGN@SAP is the hosting material.

TABLE 1
Concentrations of elements (wt %) in EGN@SAP as determined
by EDX at three scanned sites (St₁, St₂ and St₃).

| EGN@SAP | | Si | C | O | N | Sr | Al | Dy | Eu |
|---|---|---|---|---|---|---|---|---|---|
| SAN₀ | St₁ | 3.31 | 58.61 | 37.33 | 4.82 | 0 | 0 | 0 | 0 |
| | St₂ | 3.14 | 59.02 | 37.01 | 4.92 | 0 | 0 | 0 | 0 |
| | St₃ | 3.09 | 59.23 | 37.10 | 4.73 | 0 | 0 | 0 | 0 |
| SAN₁ | St₁ | 3.41 | 55.41 | 37.60 | 4.42 | 1.25 | 1.77 | 0.04 | 0.12 |
| | St₂ | 3.02 | 56.02 | 37.63 | 4.30 | 1.25 | 1.73 | 0.05 | 0.10 |
| | St₃ | 3.11 | 55.84 | 37.20 | 4.67 | 1.19 | 1.86 | 0.08 | 0.15 |
| SAN₃ | St₁ | 3.39 | 54.77 | 37.13 | 4.24 | 2.17 | 3.92 | 0.18 | 0.29 |
| | St₂ | 3.20 | 54.51 | 37.61 | 4.53 | 2.20 | 3.51 | 0.14 | 0.34 |
| | St₃ | 3.10 | 54.73 | 37.92 | 4.14 | 2.01 | 3.75 | 0.11 | 0.25 |
| SAN₆ | St₁ | 2.76 | 48.01 | 38.06 | 3.70 | 3.00 | 6.73 | 0.25 | 0.50 |
| | St₂ | 2.32 | 48.75 | 38.25 | 3.53 | 3.20 | 6.18 | 0.26 | 0.59 |
| | St₃ | 2.50 | 47.95 | 38.18 | 3.80 | 3.33 | 6.45 | 0.37 | 0.54 |
| SAN₈ | St₁ | 2.02 | 45.01 | 39.31 | 2.74 | 4.06 | 7.63 | 0.45 | 0.79 |
| | St₂ | 2.10 | 45.00 | 39.62 | 2.56 | 4.19 | 7.55 | 0.42 | 0.61 |
| | St₃ | 2.52 | 44.73 | 39.24 | 2.32 | 4.33 | 7.57 | 0.41 | 0.88 |

Table 2 shows that the bright EGN@SAP bricks' elemental composition was determined with the use of XRF analysis. The elemental composition of a substance can be precisely determined using the EDX technique. However, X-ray fluorescence (XRF) detects elements at total contents as low as 10 ppm. Thus, XRF can be applied as a partial elemental identification technique. Therefore, XRF analysis of EGN@SAP blocks detected only Sr and Al. Thus, the very small contents of Eu and Dy were undetectable. The elemental distribution in SAN and EGN@SAP bricks was found to be almost identical using EDX and XRF techniques.

TABLE 2
Elemental analysis of EGN@SAP as indicated by XRF.

Composition (wt %)

| Elements | SAN₁ | SAN₃ | SAN₆ | SAN₈ |
|---|---|---|---|---|
| Si | 99.02 | 94.57 | 90.12 | 85.14 |
| Al | 0.67 | 3.81 | 7.23 | 9.50 |
| Sr | 0.31 | 1.62 | 3.55 | 5.36 |

### Example 5

### Photoluminescence Analysis

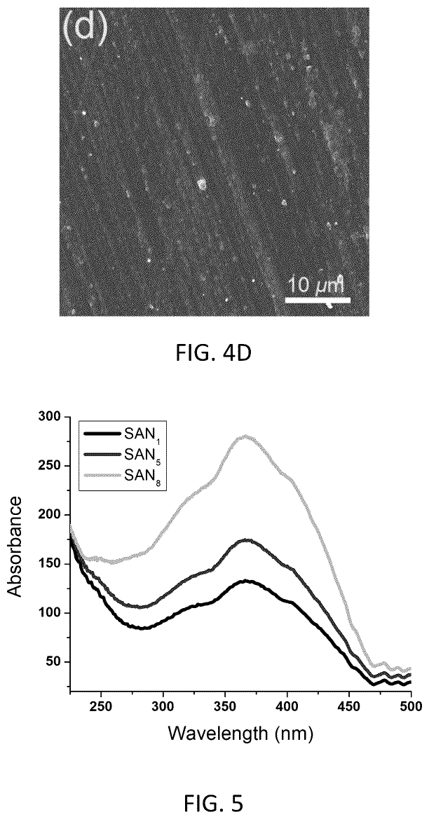

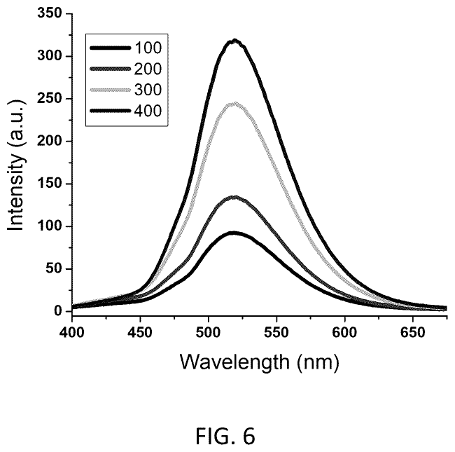

Rapid reversible photochromism was monitored in the EGN@SAP hybrid that had been loaded with phosphor. For SAN ratios of 1% or less, EGN@SAP demonstrated instantaneous reversibility of fluorescence emission. Bricks of EGN@SAP with SAN contents over 1% persisted to lighten green emission in the dark. Absorption spectra of SAN-doped EGN@SAP bricks showed that the intensity of absorption varies against the SAN content (FIG. 5). As the concentration of SAN was increased, it was found that the intensity of the absorption increased. As shown in FIG. 6, a light-dependent emission intensity of SAN-containing EGN@SAP brick (SAN₆) was detected. Thus, it was discovered that increasing the duration of UV illumination increased the emission intensity. The emission band centred about 519 nm when excited at 365 nm. The insertion of SAN improved the connections between the polymer chains of EGN@SAP by physical entrapment of SAN inside the EGN@SAP bulk or by creating coordination bonding amongst aluminum in SAN and oxygen in EGN@SAP.

Greenish phosphorescence (519 nm) has been attributed to 4fχ5d transitions of Eu(II), and no emission band was monitored for Eu(III). The exponential decay of EGN@SAP as a function of time showed a decay curve that first went off dramatically and then declined steadily. Phosphor nanoparticles were included into a transparent EGN@SAP hybrid, providing a photochromic smart brick. UV illumination revealed strong greenish emission, while daylight illumination revealed transparent appearance. The photochromic EGN@SAP can be utilized as an anti-counterfeiting thin film for various applications such as smart packaging. By modifying a square shape of the current EGN@SAP hybrid, gaskets can be made. The utilized gasket is undetectable in the visible spectrum but emits a greenish fluorescence when illuminated with UV light. The optical transmittance of EGN@SAP substrates was tested to confirm their transparency.

When the ratio of SAN is increased in EGN@SAP, the optical transmittance was slightly reduced as SAN₁ showed a value of 90% and SAN₈ showed a value of 83%. The SAN₁ and SAN₈ samples exhibited the appearance of transparency in daylight but took on a pronounced green emission when illuminated with UV. Anti-counterfeiting patterns can be developed by photoluminescent EGN@SAP film that is colorless in daylight. SAN are thought to emit light through the 4f⁶5d¹χ4f⁷ transitions of Eu(II). The absence of emission bands for Eu³⁺ or Dy³⁺ suggests that Eu³⁺ is replaced with Eu²⁺. Dy³⁺ was also observed to help Eu²⁺ to go back to its ground state by stimulating the production of traps. Photochromism and afterglow in commercial products need photostability and durability. The remarkable reversibility of SAN₆ was tested by repeatedly coloring and decoloring it with UV and visible light.

The photochromic properties of EGN@SAP bricks are shown in Table 3. From SAN₀ to SAN₆, the EGN@SAP substrates are transparent. However, SAN₇ and SAN₈ had more of the phosphor nanoparticles, giving them a slightly white appearance. Transparency in EGN@SAP bricks is guaranteed by a uniform distribution of SAN across the plastic matrix. The low nanoparticle concentration in EGN@SAP (SAN₁ to SAN₂) fluoresced green under ultraviolet light. Green phosphorescence was generated by the EGN@SAP bricks (SAN₃ to SAN₈) with high SAN concentrations when subjected to UV lightening, imparting them a greenish-yellow lightening emission in the dark. Emission from SAN₈ appears transparent in daytime, green beneath UV lightening, and greenish-yellow in a darkened room

When the quantity of SAN was increased, the EGN@SAP hybrid appeared greener when exposed to UV lightening. Under natural lightening, K/S shifted very little when the SAN ratio was increased from SAN₀ to SAN₆. However, a modest increase in K/S was tracked when the phosphor content was raised from SAN₇ to SAN₈ to signify a slightly white color. The K/S value improved when UV light was shone on EGN@SAP bulk with progressively higher concentrations of SAN, from SAN₁ to SAN₈. When UV lightening induces the greenish emission, K/S was considerable increased as compared to the un-irradiated EGN@SAP blocks. Slight shifts were detected in the CIE Lab parameters during daylight and UV illumination for the SAN-free EGN@SAP (SAN₀). In the SAN-containing EGN@SAP substrates, CIE Lab coordinates showed a diverse set of values. Raising the SAN content led to a marginal decrease in L′ in the daylight. When the concentration of SAN was increased, L′ was found to considerably decrease beneath ultraviolet lightening, designating a better green color. In the visible range, when the SAN ratio rose, the −a* and +b* values maintained approximately the same value. Beneath ultraviolet lightening, it was found that the values of −a* rose when the SAN ratio was raised, and that the magnitudes of +b* reduced when the ratio was increased. Colorless EGN@SAP hybrids (SAN₁ and SAN₂) containing less SAN ratios fluoresced only under UV illumination. However, EGN@SAP with high ratios of SAN (SAN₃ and SAN₈) persisted to emit light even after the ultraviolet source was turned off. The highest photochromic greener emission was monitored for the transparent SAN₂. SAN₆ retained its colorless appearance with the greenest phosphorescence.

TABLE 3
Coloration of EGN@SAP in visible
(VLi), and UV lightening (ULi).

| | K/S | | L* | | a* | | b* | |
|---|---|---|---|---|---|---|---|---|
| EGN@SAP | VLi | ULi | VLi | ULi | VLi | ULi | VLi | ULi |
| SAN₀ | 0.34 | 0.28 | 91.35 | 90.31 | −1.23 | −1.04 | 1.89 | 2.03 |
| SAN₁ | 0.64 | 1.29 | 89.63 | 85.64 | −1.03 | −9.48 | 1.53 | 21.34 |
| SAN₂ | 0.69 | 1.54 | 89.25 | 84.60 | −0.99 | −10.43 | 1.42 | 20.72 |
| SAN₃ | 0.72 | 1.81 | 89.09 | 83.66 | −0.86 | −13.57 | 1.38 | 18.33 |
| SAN₄ | 0.81 | 1.98 | 88.67 | 80.22 | −0.73 | −17.48 | 1.25 | 14.93 |
| SAN₅ | 0.87 | 2.25 | 88.00 | 77.53 | −0.70 | −20.57 | 1.15 | 9.10 |
| SAN₆ | 0.92 | 2.44 | 87.68 | 76.12 | −0.49 | −22.23 | 0.95 | 5.17 |
| SAN₇ | 1.21 | 2.86 | 87.33 | 72.45 | −0.33 | −24.04 | 0.88 | 3.43 |
| SAN₈ | 1.58 | 3.10 | 87.15 | 71.85 | −0.26 | −25.67 | 0.69 | 2.85 |

### Example 6

### Hydrophobicity and Ultraviolet Resistance

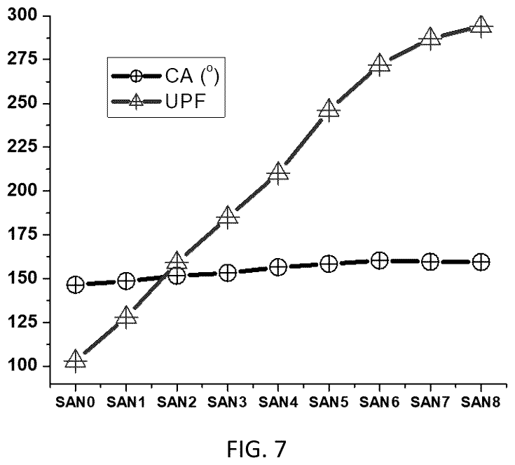

The contact angles (CA) for the EGN@SAP hybrid were raised from 146.5° for SAN₀ to 148.7° for SAN₁ with the addition of SAN content. CA was improved from 148.7° to 160.3° when the SAN ratio was increased from SAN₁ to SAN₆, respectively. When the percentage of SAN was further raised, SAN₇ (159.7°) and SAN₈ (159.5°) showed somewhat reduced roughness and contacting angles (Table 4 and FIG. 7). With UV protection built into smart windows and other building blocks, skin cancer, erythema and sunburn can be avoided.

The results of tests performed on UV blocking of the fluorescent EGN@SAP bricks are illustrated in Table 4 and FIG. 7. When applied on photoluminescent EGN@SAP substrates, SAN₁ provides a protective effect against UV light due to their high absorbance capacity of UV light. Thus, SAN₁ is so much more resistant to UV rays than SAN₀. Increasing the SAN/EGN@SAP ratio improved UV protection. As a result, a mix of SAN, EGN and styrene-acrylonitrile plastic that is transparent and emits light in the dark might be utilized to create energy-efficient windows. During the sunshine light, the photochromic EGN@SAP hybrid becomes a greenish color. Thus, up to 87% less sunlight can penetrate into the building. EGN@SAP reverts to its colorless state when natural light is scarce, letting more light into the structure.

TABLE 4
Contacting angle (CA), ultraviolet protection factor
(UPF), and tensile strength (TS) of EGN@SAP.

| EGN@SAP | CA (°) | UPF | TS |
|---|---|---|---|
| SAN₀ | 146.5 | 103 | 44.97 |
| SAN₁ | 148.7 | 128 | 48.09 |
| SAN₂ | 151.6 | 159 | 49.73 |
| SAN₃ | 153.3 | 185 | 51.25 |
| SAN₄ | 156.5 | 210 | 52.59 |
| SAN₅ | 158.5 | 246 | 54.19 |
| SAN₆ | 160.3 | 272 | 55.12 |
| SAN₇ | 159.7 | 287 | 55.53 |
| SAN₈ | 159.5 | 294 | 55.73 |

It is to be understood that the photochromic materials described herein are not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A photochromic material, consisting of:
between 0.5% w/w and 12% w/w strontium aluminate nanoparticles (SAN), wherein the SAN comprise between 0.19% w/w and 4.33% w/w strontium nanoparticles, between 1.73% w/w and 7.63% w/w aluminum nanoparticles, the photochromic material includes no more than 0.45% w/w dysropium nanoparticles and no more than 0.88% w/w europium nanoparticles, and wherein the SAN are included in a styrene-acrylonitrile polymer (SAP), wherein the SAP is reinforced with electrospun glass nanofibers (EGN) therein.

2. The photochromic material of claim 1, wherein the photochromic material is transparent.

3. The photochromic material of claim 1, wherein the photochromic material is scratch resistant.

4. The photochromic material of claim 1, wherein the photochromic material is configured to form bricks.

5. The photochromic material of claim 1, wherein the photochromic material is configured to form smart windows.

6. The photochromic material of claim 1, wherein the electrospun glass nanofibers (EGN) are a toughening mediator in the styrene-acrylonitrile polymer (SAP).

7. The photochromic material of claim 1, wherein the photochromic material exhibits a green coloration after exposure to ultraviolet (UV) light.

8. The photochromic material of claim 1, wherein the SAN have a diameter of about 6 nm to about 14 nm.

9. The photochromic material of claim 1, wherein the EGN have a diameter of about 75 nm to about 300 nm.

10. A photochromic material, consisting of:
styrene-acrylonitrile polymer (SAP) reinforced with electrospun glass nanofibers (EGN) therein,
between 0.5% w/w and 12% w/w strontium aluminate nanoparticles (SAN), wherein the SAN comprise between 0.19% w/w and 4.33% w/w strontium nanoparticles, between 1.73% w/w and 7.63% w/w aluminum nanoparticles, the photochromic material includes no more than 0.45% w/w dysropium nanoparticles and no more than 0.88% w/w europium nanoparticles, and wherein the SAN are included within the styrene-acrylonitrile polymer (SAP) reinforced with electrospun glass nanofibers (EGN),
wherein the photochromic material is transparent.

11. The photochromic material of claim 10, wherein the photochromic material is configured to form bricks.

12. The photochromic material of claim 10, wherein the photochromic material is configured to form smart windows.

13. The photochromic material of claim 10, wherein the electrospun glass nanofibers are a toughening mediator in the styrene-acrylonitrile polymer (SAP).

14. The photochromic material of claim 10, wherein the photochromic material exhibits a green coloration after exposure to ultraviolet (UV) light.

15. The photochromic material of claim 10, wherein the SAN have a diameter of about 80 nm to about 120 nm.

16. The photochromic material of claim 10, wherein the EGN have a diameter of about 75 nm to about 180 nm.

17. The photochromic material of claim 10, wherein the photochromic material is scratch resistant.
